(19) United States
(12) Patent Application Publication
(10) Pub. No.: US 2011/0090642 A1
(43) Pub. Date: Apr. 21, 2011

(54) Heat Dissipation Device

(76) Inventor: Deng-Hsi Chen, Keelung (TW)

(21) Appl. No.: 12/196,741

(22) Filed: Aug. 22, 2008

(30) Foreign Application Priority Data
Jun. 3, 2008 (TW) 097209759

(51) Int. Cl. G06F 1/20

(52) U.S. Cl. 361/679.48

(57) ABSTRACT

A heat dissipation device which is assembled in a computer case is primarily constituted by a cooling fan, a circuit drive unit, an MCU (Microcontroller Unit) chip and a light emitting unit. The MCU chip is used to detect a power load of a power supply, and the circuit drive unit is used to drive the light emitting unit to produce a change of various light colors, according to a result of detection; this allows a user to identify a power load and output of the power supply by watching directly.

### BACKGROUND OF THE INVENTION

a) Field of the Invention

The present invention relates to a heat dissipation device which is assembled in a computer case, and more particularly to a heat dissipation device which uses a change of light colors of a light emitting unit to allow a user to be aware of a change of power load and output from a power supply by watching directly.

b) Description of the Prior Art

A heat dissipation device generally refers to a device which can dissipate heat from a specific heat source, such as a cooling fan, a cooling fin, a heat pipe or even a combination of the aforementioned devices. Among the aforementioned devices, the cooling fan is applied most broadly, and acts usually as a base for dissipating heat, assisted with the cooling fin or other heat dissipation devices, to be assembled in a computer case. The primary function of the cooling fan is to quickly produce proper or forced convection to air in a specific area after being energized to operate that, for example, hot air in a specific area is expelled quickly or air of lower temperature is quickly carried to the specific area, so as to achieve the effects of dissipating heat and reducing temperature, thereby prohibiting operating temperature of an electronic device in the specific area from rising excessively, in order to assure the effectiveness of operation. There are many kinds of cooling fans sold on markets, primarily focusing on rotation speed and silence; whereas, some cooling fans are matched with light emitting units. Referring to FIG. 1, it shows a three-dimensional view of a conventional light emitting heat dissipation device, wherein a light emitting heat dissipation device 10 includes primarily a solid cooling fan 101 and a plurality of light emitting diodes 102. The primary function of the device is that the light emitting diodes 102 can produce a fancy effect of light when the cooling fan 101 is operating. Nevertheless, in a realistic application, the light emitting unit only manifests a visual effect. Although the existing object of the light emitting unit has been achieved, further providing the light emitting unit with other functions to improve the practicability is an issue to be solved by the present inventor.

### SUMMARY OF THE INVENTION

The primary object of the present invention is to provide a heat dissipation device, wherein a function of a light emitting unit in the heat dissipation device is extended, allowing light colors of the light emitting unit to have a corresponding operation in response to a change of power load, such that a user can identify a current power load or output condition of the power supply by watching directly. Accordingly, a heat dissipation device of the present invention includes primarily a cooling fan, a circuit drive unit, an MCU chip (the Microcontroller Unit chip is a chip into which a ROM (Read-Only Memory), a RAM (Random-Access Memory), a CPU (Central Processing Unit) and an I/O (Input/Output) unit are assembled according to various application conditions) and a light emitting unit, wherein the circuit drive unit, the MCU chip and the light emitting unit are assembled in the cooling fan, and the light emitting unit is assembled on physical appearance of the cooling fan, such as a frame or a fan blade, allowing a user to directly identify with eyes. Moreover, by using the MCU chip to detect and process the power load of the power supply, converting the detected value to a corresponding parametric signal which is then outputted to the circuit drive unit, before driving the light emitting unit by the circuit drive unit, such that the light emitting unit is able to produce a corresponding change of light colors according to the parametric signal.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional view of a conventional light emitting cooling fan.

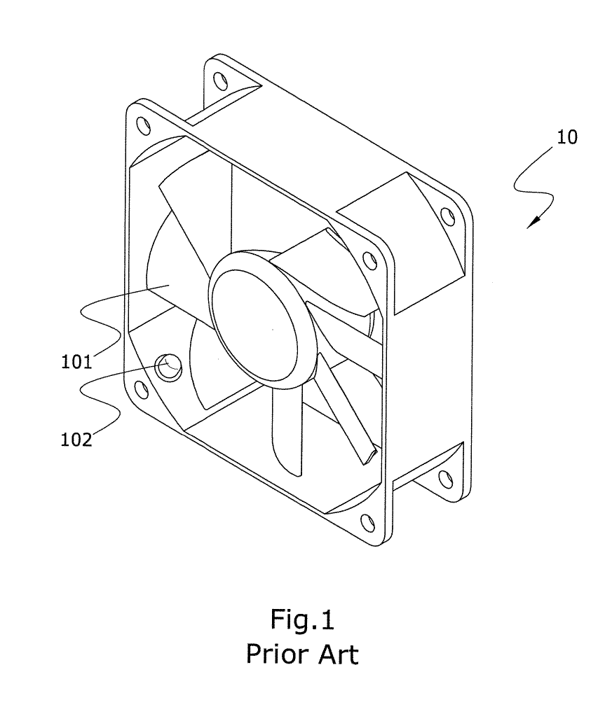

FIG. 2 shows a schematic view of units that constitute the present invention.

FIG. 3 shows a schematic view of an implementation of the present invention.

FIG. 4 shows a flow diagram of an operation of the present invention.

### DETAILED DESCRIPTION OF THE PREFERRED EMBODIMENTS

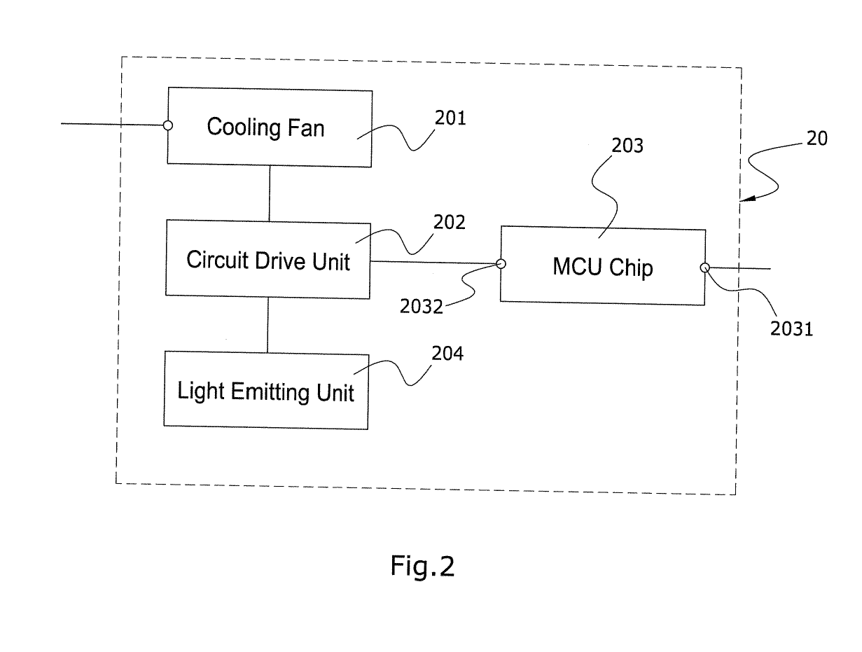

Referring to FIG. 2, it shows a schematic view of units that constitute the present invention, wherein a heat dissipation device 20 comprises primarily a cooling fan 201, a circuit drive unit 202, an MCU (Microcontroller Unit) chip 203 and a light emitting unit 204. After being energized, the cooling fan 201 rotates to result in air flow. The circuit drive unit 202 is assembled in the cooling fan 201 and is connected to a power source. The MCU chip 203 is assembled in the cooling fan 201 and is provided with a detection end 2031 and a signal output end 2032 which is electrically connected with the circuit drive unit 202; whereas, the detection end 2031 is connected to a power supply (not shown in the drawing). The primary function of the detection end 2031 is to detect a power load or output condition of the power supply, such as a change of output current value, a change of voltage value or a change of electric power value, after being electrically connected. After detecting, the value detected, such as electric power (watt), is converted into a parametric signal which is then transmitted to the circuit drive unit 202. The circuit drive unit 202 will drive the light emitting unit 204 using the parametric signal that has been received. On the other hand, the light emitting unit 204 disclosed by the present invention generally refers to all kinds of light emitting diodes that can emit light. The light emitting unit 204 is electrically connected with the circuit drive unit 202 and emits light or produces the parametric signal of the change of light colors, after being driven by the circuit drive unit 202. For example, darkness of the light color or a variation of light color conversion is produced by the light emitting unit 204 which is driven according to the parametric signal. Moreover, the light emitting unit 204 can be assembled at physical appearance of the cooling fan 201, such as inside a frame, on an outer rim, on a fan blade or even on an outer circumference of a rotor, allowing the effect of light emission to be directly aware of with eyes and identified by an operator.

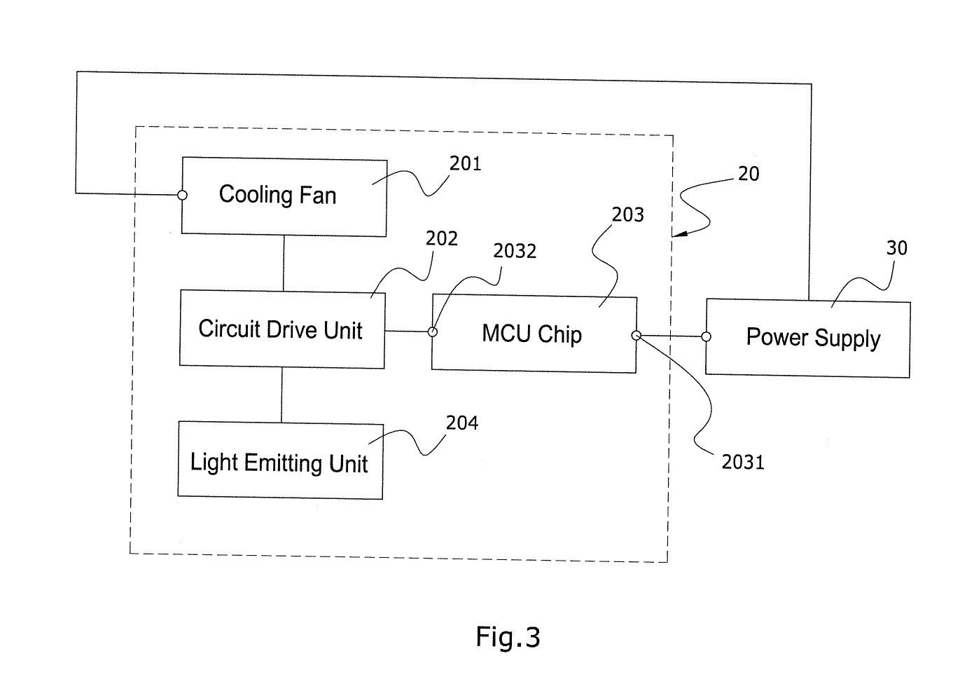

Referring to FIG. 3, it shows a schematic view of an implementation of the present invention, wherein the entire heat dissipation device 20 is assembled in an area where heat dissipation is required, inside a computer case. Upon applying the present invention, the detection end 2031 of the MCU chip 203 is electrically connected with a power supply 30 (i.e., the power supply that is installed inside the computer case), and the power supply 30 is electrically connected with the cooling fan 201 and the circuit drive unit 202, respectively. When the power supply 30 is operating to supply power as needed, a corresponding current, voltage or electric power will be outputted in accordance with an operation condition of the entire system. Therefore, the output value will be different according to the power load. As the power supply 30 is electrically connected at the detection end 2031 of the MCU chip 203, when the power output of the power supply 30 varies, the MCU chip 203 will detect the value of power output of the power supply 30 through the detection end 2031, convert the change value that has been detected into a corresponding parametric signal, and output this parametric signal to the circuit drive unit 202 from the signal output end 2032. The circuit drive unit 202 will then drive the light emitting unit 204 according to the parametric signal that has been received. For example, when the MCU chip 203 has detected that the power supply 30 is at a high power load, the MCU chip 203 will convert the detected value into the parametric signal and output the parametric signal to the circuit drive unit 202. The circuit drive unit 202 will then drive the light emitting unit 204 to emit red light, according to the parametric signal that has been received, so as to alert the user that the power supply 30 is currently at the high power load. Moreover, the change of light colors can be designed as needed, such as that red light means that the power output of the power supply 30 is at a high power load, and blue light represents that the power supply 30 is at a normal power load. On the other hand, the power supply 30 can be connected respectively to other electronic devices in the computer case, e.g., a CPU (Central Processing Unit) or a display card. Therefore, the more the electronic devices that are connected to the power supply 30, the higher the power load that is outputted. Upon implementing the present invention, the user can visually identify the current power load outputted from the power supply 30 using the light emitting unit 204 provided on the heat dissipation device 20, so as to better keep track of the power supply condition of the power supply 30. Furthermore, the light emitting unit 204 disclosed by the present invention can be any kind compliance with a specification of assembly size, e.g., a lamp or a surface mounted device (SMD). The light emitting unit 204 can be also a light emitting diode module constituted by one single-chip, one multi-chip or a plurality of them. In a realistic application, single-color light emission, multi-color light emission, blended-color light emission or a change of color gradients can be achieved by choosing and matching according to color saturation and color level.

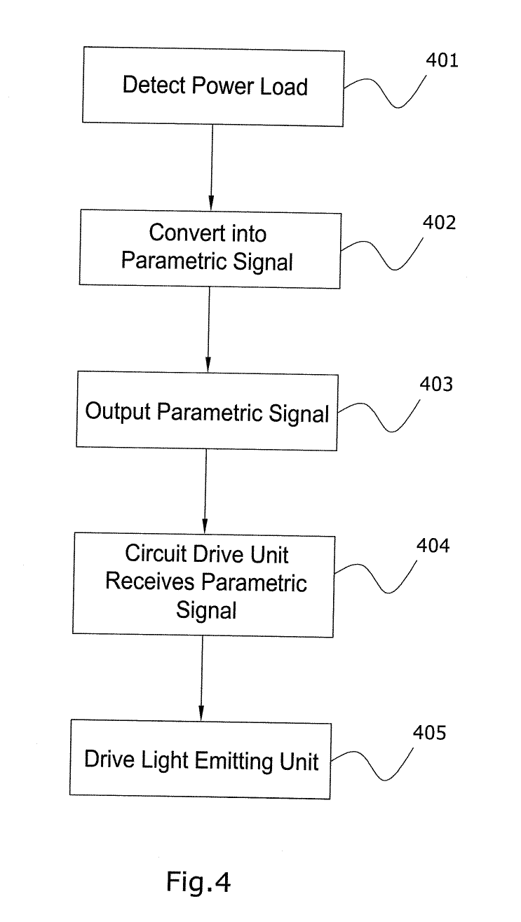

Referring to FIG. 3 and FIG. 4, it shows a schematic view of an implementation and a flow diagram of an operation, of the present invention, including following steps:

Detecting the power load 401—when the power supply 30 is operating, the MCU chip 203 will detect the power load (can be any one of the current value, the voltage value and the electric power value, or a combination of the three values) outputted by the power supply 30;

Converting into the parametric signal 402—the MCU chip 203 converts the detected value into the corresponding parametric signal;

Outputting the parametric signal 403—the MCU chip 203 outputs the parametric signal from the signal output end 2032 to the circuit drive unit 202 that is electrically connected;

Receiving the parametric signal by the circuit drive unit 404—after

Receiving the parametric signal by the circuit drive unit 404—after the circuit drive unit 202 has received the parametric signal transmitted by the MCU chip 203, a driving voltage or current is produced according to the parametric signal;

Emitting light from the light emitting unit 405—after the light emitting unit 204 has been driven, the light emitting unit 204 produces the corresponding light or the change of light colors.

Accordingly, the heat dissipation device 20 of the present invention employs primarily the MCU chip 203 which converts the change of power output that has been detected into the parametric signal to be outputted, further allowing the circuit drive unit 202 to drive the light emitting unit 204, according to the parametric signal, to produce the corresponding light colors. Therefore, the user can directly identify with eyes to immediately recognize the power load of the power supply 30. After being implemented, the present invention actually achieves the function of providing an extended light emitting unit in the heat dissipation device, enabling the light colors to have a corresponding operation in response to the change of power output, such that the user can directly identify with eyes the current power load of the power supply. herein is merely illustrative of the principles of the invention and that a wide variety of modifications thereto may be effected by persons skilled in the art without departing from the spirit and scope of the invention as set forth in the following claims.

What is claimed is:

1. A heat dissipation device which is assembled in a computer case, comprising a cooling fan which produces air flow after being energized; an MCU (Microcontroller Unit) chip, which is assembled in the cooling fan and is provided with a detection end and a signal output end, with the detection end being connected to a power supply to detect a power load of the power supply and to convert a result of detection into a corresponding parametric signal; and a circuit drive unit, which is electrically connected with the signal output end of the MCU chip to receive the parametric signal outputted by the MCU chip and to drive a light emitting unit, according to the received parametric signal, to emit light correspondingly.

2. The heat dissipation device according to claim 1, wherein the light emitting unit is a light emitting diode.

3. The heat dissipation device according to claim 1, wherein the light emitting unit is assembled at any part on physical appearance of the cooling fan.

4. The heat dissipation device according to claim 1, wherein the parametric signal is a conversion parameter corresponding to a

5. The heat dissipation device according to claim 1, wherein the parametric signal is a conversion parameter corresponding to a voltage value outputted from the power supply.

6. The heat dissipation device according to claim 1, wherein the parametric signal is a conversion parameter corresponding to an electric power value outputted from the power supply.
